(19) United States
(12) Patent Application Publication
(10) Pub. No.: US 2022/0167465 A1
(43) Pub. Date: May 26, 2022

(54) FLEXIBLE AND STRETCHABLE ELECTRIC HEATER BASED ON ELECTRICALLY CONDUCTIVE TEXTILE MATERIAL AND METHOD OF MANUFACTURING SAME

(71) Applicant: IEE INTERNATIONAL ELECTRONICS & ENGINEERING S.A., ECHTERNACH (LU)

(72) Inventors: Cedric AMOROSI, Gorcy (FR); Driss CHABACH, Noertrange (LU)

(21) Appl. No.: 17/434,192

(22) PCT Filed: Feb. 26, 2020
(86) PCT No.: PCT/EP2020/055015

§ 371 Date: Aug. 26, 2021

(30) Foreign Application Priority Data
Feb. 26, 2019 (LU) LU 101137
Mar. 7, 2019 (LU) LU 101148
Apr. 30, 2019 (LU) LU 101201

(51) Int. Cl. H05B 3/34; B62D 1/06; B60H 1/22; H05B 3/14; G01D 5/24

(52) U.S. Cl. CPC H05B 3/347; B62D 1/065; B60H 1/2227; B32B 38/0004; G01D 5/24; H05B 2203/017; H05B 2203/015; H05B 3/146

(57) ABSTRACT

An electric heating member, in particular for automotive application, includes an electrically conductive, flat-shaped textile member of uniform thickness and a layer of flexible, polymeric plastic material that is adhesively bonded to a surface of the textile member. The electrically conductive textile member is formed by at least two electrically conductive textile member parts that are arranged side by side and are electrically separated. At least one of the at least two textile member parts is electrically connected to electric terminals that are connectable to an electric heater power supply unit. The electric heating member is particularly intended to be used for heating a vehicle steering wheel.

### TECHNICAL FIELD

The invention relates to an electric heating member, in particular for automotive application, and a method of manufacturing such electric heating member.

### BACKGROUND

Electric heating devices employing one or more electric heating members are widely used in the automotive industry for providing passenger comfort, for instance by heating a vehicle compartment in general, and/or passenger seats, and/or arm rests, and/or panels. Electric heating devices are also employed in vehicle steering wheels for heating right after start-up of a vehicle engine at cold ambient conditions.

It is considered as one requirement for such electric heating members that they should be unnoticeable to the vehicle user if not put into operation. Another requirement is an as even as possible heating up during operation, for instance within a range of a few degrees ° C., in order to avoid hot spots that may become noticeable to the vehicle user, and also to avoid material fatigue by the occurrence of thermal stress.

These requirements generally rule out the use of conventional heating wires such as wires made from copper or from copper-nickel(-manganese) alloys, whose resistivity temperature dependence is very low.

Solutions have been proposed in the prior art that employ foil heater members, i.e. heater members having the appearance of a thin flexible foil or film.

For instance, international application WO 2015/024909 A1 describes a foil heater for a heating panel. The foil heater comprises a first and a second spiral resistive heating trace formed in a first and a second layer, respectively, that conforms to a flat or curved surface. Each of the first and second resistive heating traces has a center and at least one outer extremity. An electrically insulating layer is arranged between the first and second layer. The electrically insulating layer comprises an opening that accommodates an electrical via, through which the first and second resistive heating traces are electrically contacted with each other. The foil heater is compatible with operation at lower temperature. Due to their spiral shape, the heating traces can be routed densely over the entire heating surface substantially without crossings. A significantly more uniform temperature distribution can thus be achieved.

A 3-D installation as in the case of a conventional vehicle steering wheel places higher demands on an unnoticeable installation at the steering wheel than an even or a slightly curved surface, as wrinkles must not be present despite the curved surfaces. Another requirement is that a heater member should cover an as large as possible surface of the steering wheel.

A solution particularly for steering wheel heating is described in WO 2016/096815 A1, in which a planar flexible carrier is proposed for use in steering wheel heating and/or sensing. The planar carrier, which can be employed for mounting on a rim of a steering wheel without wrinkles, comprises a portion of planar flexible foil of roughly rectangular shape having two longitudinal sides and two lateral sides. A length B of the lateral sides is 0.96 to 1.00 times the perimeter of the rim. A number of N cut-outs per unit length are provided on each of the longitudinal sides, wherein the cut-outs of one side are located in a staggered fashion relative to opposing cut-out portions on the opposite side.

In one embodiment proposed in WO 2016/096815 A1, a planar, flexible carrier which covers a maximum of the rim surface area supports a parallel electrical heating circuit and so constitutes a heating member. Two of these heating members are attached on the steering wheel rim so that their contacted sides abut to each other and contacts of the same electrical potential are also abutting. The planar, flexible carrier consists of thermo-stabilized, 75 μm polyester foil. The foil serves as a substrate for the polymer thick film (PTF) electrical heating circuit which is applied in three printing passes by flat bed or rotary screen printing. The parallel electrical circuit is applied using a highly conductive PTF silver for the feedlines and for heating, and a low conductive PTF carbon black exhibiting positive temperature coefficient of resistivity (PTCR) characteristics for heating. A print thickness is typically between 5 and 15 μm. The document also describes the use of a stretchable planar flexible foil as a planar carrier for further shaping enhancement.

Another approach has been taken in WO 2013/050621 A2, which describes electrically conductive textiles for occupant sensing and/or heating applications, wherein the sensor and/or heater can be attached from the backside to a surface such as a driver seat, a passenger seat, a backseat, a steering wheel, a door side of compartment, a gear shift lever, and so forth.

A flexible heater and/or electrode comprises a woven textile material having a warp direction and a weft direction. The textile material comprises at least one region having a low electrical conductance and at least two regions having a high electrical conductance. The at least two regions of high electrical conductance are adjacent to the at least one region of low electrical conductance. At least one of the at least two regions of high electrical conductance is operatively connected to a connection terminal of the heater and/or electrode, wherein the connection terminal serves for connecting the heater and/or electrode to an electronic control circuit.

At least one region having a low electrical conductance is provided by the use of electrically conductive weft and/or warp yarns in a suitable thread density. Alternatively, or additionally the at least one region having a low electrical conductance is provided by applying, preferably printing, a low conductivity material onto a woven textile made of non-conductive yarns or of low conductance yarns. At least one of the at least two regions of high electrical conductance is provide by the use of high conductance weft or warp yarns. Alternatively, or additionally at last one of the at last two regions of high electrical conductance is provided by applying, preferably printing, a high conductivity material adjacent to the at least one region having a low electrical conductance onto a woven textile made of non-conductive yarns or of low conductance yarns.

Generally speaking, while a conductive textile provides much-desired flexibility properties, particularly in 3-D installations, the same properties cause a high degree of care for processing, such as positioning, cutting to different shape, handling, and so forth, making an installation quite complicated and time-consuming for an operator. In addition, this mechanical behavior tends to increase the risk to create kinks or bends during a manufacturing process, with a potential undesired increase of a local resistance.

Flexibility and stretchability are considered essential requirements for electric heater members in a 3-D integration, in particular for a steering wheel application, where elongations up to 20% at maximum forces of about 100 N are standard. Electrically conductive textiles that are based on woven textiles show little stretchability, making it hard to meet existing requirements.

### SUMMARY

It is therefore an object of the invention to provide a flexible and stretchable electric heater member, particularly for automotive applications, that is based on electrically conductive textile material, which is easy to install, shows high fault tolerance regarding installation and handling, and which preferably at the same time meets the requirements with regard to uniform heating and an as low as possible visibility and tactility in an installed state.

In one aspect of the present invention, the object is achieved by an electric heating member, comprising an electrically conductive, flat-shaped textile member of uniform thickness and a layer of flexible, polymeric plastic material. The electrically conductive, flat-shaped textile member has a planar upper surface and a planar opposite lower surface arranged in parallel to the upper surface. The layer of flexible, polymeric plastic material is adhesively bonded to one out of the upper surface and the lower surface of the textile member, thus covering a major part of the respective surface.

The electrically conductive textile member is formed by at least two electrically conductive textile member parts that are arranged side by side and are electrically separated by a kiss cutting process with regard to a direction that is aligned perpendicular to an extension direction of the textile member parts, and wherein at least one of the at least two textile member parts is electrically connected to electric terminals that are connectable to an electric heater power supply unit. The at least two electrically conductive textile member parts are preferably separated by a kiss cutting process where the electrically conductive textile member is cut through, but the adhesively bonded layer of flexible, polymeric plastic material is not, at least not through its entire thickness. It will be appreciated that the kiss cutting process may be a die cutting process employing a sharp cutting metal or a laser cutting process with a highly accurate laser beam, but in contrast to the classical die cutting or laser cutting process, kiss cutting does not penetrate the bottom layer, or the liner, of the material being cut.

For the purposes of the present invention, the term “textile” shall particularly be understood to encompass any flexible material consisting of a network of natural or synthetic fibers, e.g. yarns or threads. Yarn may be produced by spinning raw natural fibers such as wool, flax, cotton, hemp, or other materials such as synthetic fibers, to produce long strands. Textiles may be produced by weaving, knitting, crocheting, knotting, felting, or braiding. Woven textiles are to be understood in particular as a surface fabric comprising at least two interlaced thread systems arranged essentially perpendicular to one another (for instance warp and weft). In this context, a knitted textile or knitted fabric is to be understood in particular to mean a textile produced by interlooping of yarns. The term “textile” shall also include non-woven fabrics made from intermingled or bonded-together fibers and shall encompass felt, which is neither woven nor knitted.

The phrase “covering a major part”, as used in this application, shall be understood as a covered portion of more than 70%, more preferable of more than 80%, and, most preferable, of more than 90% of the respective surface. The phrase shall as well encompass a portion of 100%, i.e. a complete coverage of the respective surface by the layer of flexible, polymeric plastic material.

The term “electrically separated”, as used in this application, shall be understood such that an electrical contact resistance, in the direction perpendicular to the extension direction, between the at least two textile member parts is at least ten times as large, preferably at least twenty times as large, and, most preferably, at least fifty times as large as an electrical resistance along the extension direction of each one of the at least two textile member parts.

The phrase “extension direction of a textile member part”, as used in this application, shall be understood as a direction of a path connecting ends of the respective textile member part.

One advantage of the proposed electric heating member in accordance with the invention lies in that a stiffness of the textile-based heating member can be laid out, to a large extent by selection of an appropriate material and thickness of the polymeric plastic material layer, such that the electric heater member inherently shows high fault tolerance regarding handling and its further processing, particularly installing, can be simplified. In this way, a risk of creating strong kinks in the electrically conductive textile member with the consequence of an occurrence of cracks and/or fissures and subsequent deterioration of heating performance can substantially be reduced.

Another advantage is that the electric heating member in accordance with the invention can have a uniform thickness and an uninterrupted and unaffected width in a direction perpendicular to the extension direction and parallel to the upper and lower surface, irrespective of the electrically conductive textile member parts being part of an electric circuitry or not. In this way, due to the uniform thickness and the uninterrupted and unaffected width of the electric heating member, a possible visibility and tactility can be kept very low in an installed state.

The present invention is beneficially employable in particular in the field of automotive applications, but could also be used with advantage in building construction or in medical applications. The term “automotive”, as used in this patent application, shall particularly be understood as being suitable for use in vehicles including passenger cars, trucks, semi-trailer trucks and buses.

The electrically conductive, flat-shaped textile member may be manufactured by attaching a layer of electrically conductive material to the textile member by applying a physical vapor deposition (PVD) method such as vacuum evaporation deposition or a sputtering process, or can be attached galvanically by electroplating. Various methods of manufacturing electrically conductive textile members for capacitive sensing and/or heating applications are for instance described in WO 2013/050621 A2, which shall hereby be incorporated by reference in its entirety with effect for those jurisdictions permitting incorporation by reference. An appropriate electric resistance of the electrically conductive textile member can be adjusted by selecting a type of textile, an electrically conductive material, and an applied conductive material area weight.

The layer of flexible, polymeric plastic material can be made from, without being limited to, polyurethane (PU) and/or the group of acrylic resins, i.e. polymeric plastic materials derived from acrylic acid, methacrylic acid or other related compounds. However, also other materials that appear to be suitable to those skilled in the art may be employed.

Preferably, the textile member is formed by a plurality of more than two textile member parts that are arranged side by side and are electrically separated with regard to a direction that is aligned perpendicular to an extension direction of the textile member parts such that each adjacently arranged two textile member parts are mutually electrically separated. In this way, an electrically conductive textile member can be provided with a plurality of electrically conductive textile member parts for carrying heating currents without the mentioned disadvantages known from metal wire designs.

In preferred embodiments of the electric heating member, each textile member part of the plurality of more than two textile member parts is meander-shaped. In this way, an improved uniformity with respect to heating up can be accomplished by applying a lower electric power density (i.e. electric power per unit area), while at the same time the advantage of a uniform thickness of the electric heating member can be maintained.

Preferably, the electric heating member further comprises an adhesive layer that is adhesively bonded to the one of the surfaces of the textile member that is arranged opposite of the plastic material layer. The adhesive layer can further simplify an installation of the electric heating member especially in 3-D-applications, such as a vehicle steering wheel. For improved ease of handling, a top surface of the adhesive layer may be covered by a paper liner, which is to be removed during an installation of the electric heating member.

In preferred embodiments of the electric heating member, the electrically conductive textile member is made for the most part from polyamide, polyester, or a combination of both. The phrase “for the most part”, as used in this application, shall particularly be understood as a volumetric portion of at least 50%, more preferable of more than 70%, and, most preferable, of more than 80% of the textile member. In this way, for a specific application a suitable textile material and its processing can be selected from a large pool of different well-known textile types and production methods.

In preferred embodiments of the electric heating member, in which the electrically conductive textile member comprises warp and weft yarns, the two or the more than two electrically conductive textile member parts are aligned such that extension directions of the two or the more than two electrically conductive textile member parts form an acute angle with the warp yarns or the weft yarns that lies in a range between 15° and 75°. By that, an improved stretchability of the electric heating member and improved fault tolerance regarding handling can be achieved, with the effect of an improved ease of assembly.

In another aspect of the invention, the object is achieved by a method of manufacturing an electric heating member, in particular for automotive application. The method includes at least the steps of:
providing an electrically conductive, flat-shaped textile member of uniform thickness having a planar upper surface and a planar opposite lower surface arranged in parallel to the upper surface,
adhesively bonding a layer of flexible, polymeric plastic material to one out of the upper surface and the lower surface of the textile member, thus covering a major part of the respective surface in a direction perpendicular to the respective surface, and
separating the electrically conductive textile member into two or more electrically conductive textile member parts that are arranged side by side and are electrically separated with regard to a direction that is aligned perpendicular to an extension direction of the textile member parts such that each two adjacent textile member parts are mutually electrically separated.

According to an aspect of the invention, the step of separating the textile member into two or more textile member parts is carried out by using a kiss cutting process, by which the textile member is cut from an outside to the polymeric plastic material layer while the adhesively bonded layer of polymeric plastic material is not cut, at least not through its entire thickness. It will be appreciated that the kiss cutting process may be a die cutting process employing a sharp cutting metal or a laser cutting process with a highly accurate laser beam, but in contrast to the classical die cutting or laser cutting process, kiss cutting does not penetrate the bottom layer, or the liner, of the material being cut. In this way, the step of electrically separating the electrically conductive textile member into two or more electrically conductive textile member parts can be executed in an effective and reliable manner without substantially reducing the stiffness of the textile-based heating member which is determined to a large extent by the selection of an appropriate material and thickness of the polymeric plastic material layer. It follows that the electric heater member inherently shows high fault tolerance regarding handling and its further processing, particularly installing, can be simplified.

The benefits described in context with the proposed electric heating member apply to the proposed method of manufacturing the electric heating member to the full extent.

Preferably, the method further comprises a step of adhesively bonding an adhesive layer to the one of the surfaces of the textile member that is arranged opposite of the plastic material layer. The adhesive layer can further simplify an installation of the electric heating member especially in 3-D-applications, such as a vehicle steering wheel. For improved ease of handling, a paper liner may be attached to a top surface of the adhesive layer in an additional step. The paper liner is to be removed in another step prior to or during an installation of the electric heating member.

In another aspect of the invention, a use of at least one of the described electric heating members for heating a vehicle steering wheel is proposed, providing many of the benefits described in context with the electric heating member disclosed herein.

In a further aspect of the invention, a use of at least one of the described electric heating members as an antenna member of a capacitive sensing device for automotive application is proposed. By that, many of the benefits described in context with the electric heating member disclosed herein can be combined with the benefits of using an electric heating member as an antenna member of a capacitive sensing device in the vehicle, as has been proposed, by way of example, in DE 41 10 702 A1, in which a vehicle seat is described with an electric seat heater comprising a conductor which can be heated by the passage of electrical current through it. The conductor is located in the seating surface and forms a part of a capacitive sensor for detecting a seat occupancy of the seat.

These and other aspects of the invention will be apparent from and elucidated with reference to the embodiments described hereinafter.

It shall be pointed out that the features and measures detailed individually in the preceding description can be combined with one another in any technically meaningful manner and show further embodiments of the invention. The description characterizes and specifies embodiments of the invention in particular in connection with the figures.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates a possible embodiment of an electric heating member in accordance with the invention in a sectional side view in various stages of manufacturing,

FIG. 2 schematically illustrates the electric heating member pursuant to FIG. 1 at the end of manufacturing,

FIG. 3 is a plan view on a detail of the electric heating member pursuant to FIG. 1,

FIG. 4 shows a schematic representation of the electrically conductive, flat-shaped textile member of the electric heating member pursuant to FIG. 1 in a plan view,

FIG. 5 schematically shows a vehicle steering wheel with a capacitive hands-off detection system using the electric heating member pursuant to FIG. 1, and

FIG. 6 is a flow chart of a method of manufacturing the electric heating member pursuant to FIG. 1.

### DETAILED DESCRIPTION

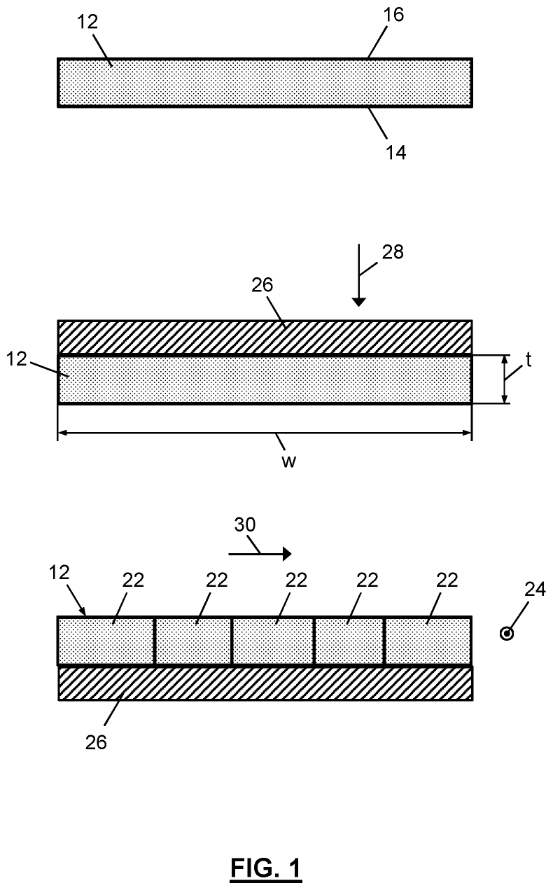

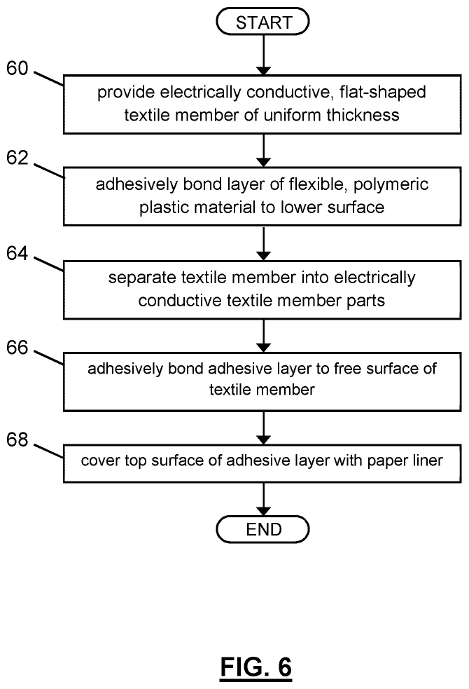

FIG. 1 schematically illustrates a possible embodiment of an electric heating member 10 in various stages of manufacturing, in a lateral sectional view. A flowchart of a method of manufacturing the electric heating member 10 pursuant to FIG. 1 is shown in FIG. 6, and steps of the method will be described with reference to FIG. 1 or FIG. 2 and FIG. 6, respectively. The electric heating member 10 is intended for use in a heatable vehicle steering wheel. As will be described later, the electric heating member 10 is also intended to be used as an antenna member of a capacitive hands-off detection system for the vehicle steering wheel.

In one step 60 of the method, an electrically conductive, flat-shaped textile member 12 of uniform thickness t and width w is provided (FIG. 1, middle). The electrically conductive textile member 12 has a planar upper surface 14 and a planar opposite lower surface 16 arranged in parallel to the upper surface 14 (FIG. 1, above). The textile member 12 is woven, comprising warp and weft yarns, and may be made for the most part from polyester, in particular polyethylene terephthalate (PET). Electrically conductive material such as copper or aluminum may be attached to the upper surface 14 and/or the lower surface 16, for instance by a PVD method like vacuum deposition, with a predetermined material area weight for achieving an appropriate electric resistance of the electrically conductive textile member 12.

In a next step 62 of the method, a layer of flexible, polymeric plastic material 26 is adhesively bonded to the lower surface 16 of the textile member 12, thus completely covering the lower surface 16 in a direction 28 perpendicular to the lower surface 16 (FIG. 1, middle). The polymeric plastic material 26 may be formed by polyurethane (PU). The adhesive bond may be established by a printing process, a commabar process or a slot die process.

In a following step 64 of the method, the electrically conductive textile member 12 is separated into a plurality of electrically conductive textile member parts 22 that are arranged side by side. By applying a kisscut process with specific, predetermined settings, by which the textile member 12 is cut from an outside to the polymeric plastic material layer 26, the electrically conductive textile member parts 22 are electrically separated with regard to a direction 30 that is aligned parallel to the lower surface 16 and perpendicular to an extension direction 24 of the textile member parts 22 such that each two adjacent textile member parts 22 are mutually electrically separated. In FIG. 1, the extension direction 24 of the textile member parts 22 is arranged perpendicular to the plane of the drawing. The electrically conductive textile member 12 is thus formed by the plurality of electrically conductive textile member parts 22 (FIG. 1, below; illustration is turned upside down compared to upper and middle illustration).

The electrically conductive textile member parts 22 may be meander-shaped, as is illustrated in FIG. 3 for a plurality of eight electrically conductive textile member parts 22, or they may have a straight, rectangular shape. It shall be noted that gaps between adjacent textile member parts 22 are highly exaggerated in FIG. 3 for clarity purposes. In reality, the gap between adjacent electrically conductive textile member parts 22 is just large enough for electrical separation, so that the width w of the electrically conductive textile member 12 in the direction 30 parallel to the lower surface 16 and perpendicular to the extension direction 24 of the textile member parts 22 is virtually uninterrupted and unaffected. The electrically conductive textile member parts 22 are electrically connected to electric terminals (not shown) that are connectable to an electric heater power supply unit for providing electric heating power.

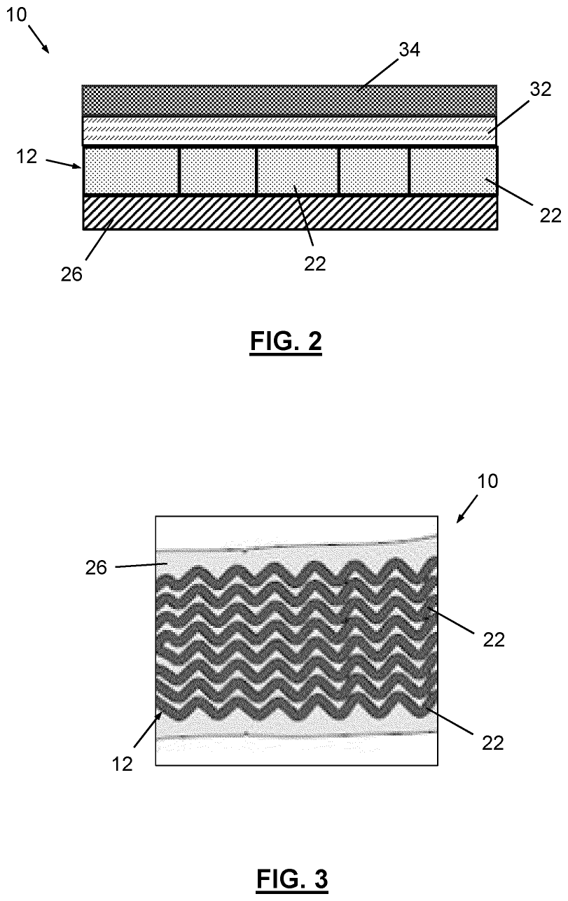

With reference to FIG. 2 and FIG. 6, in a further step 66 of the method, an adhesive layer 32 is adhesively bonded to the upper surface 14 of the textile member 12 that is arranged opposite of the plastic material layer 26. For improved ease of handling, a free surface of the adhesive layer 32 is covered with a paper liner 34 in another step 68. FIG. 2 schematically illustrates the electric heating member 10 pursuant to FIG. 1 at the end of manufacturing, in a ready-for-use state. The paper liner 34 is to be removed prior to or during an installation of the electric heating member 10.

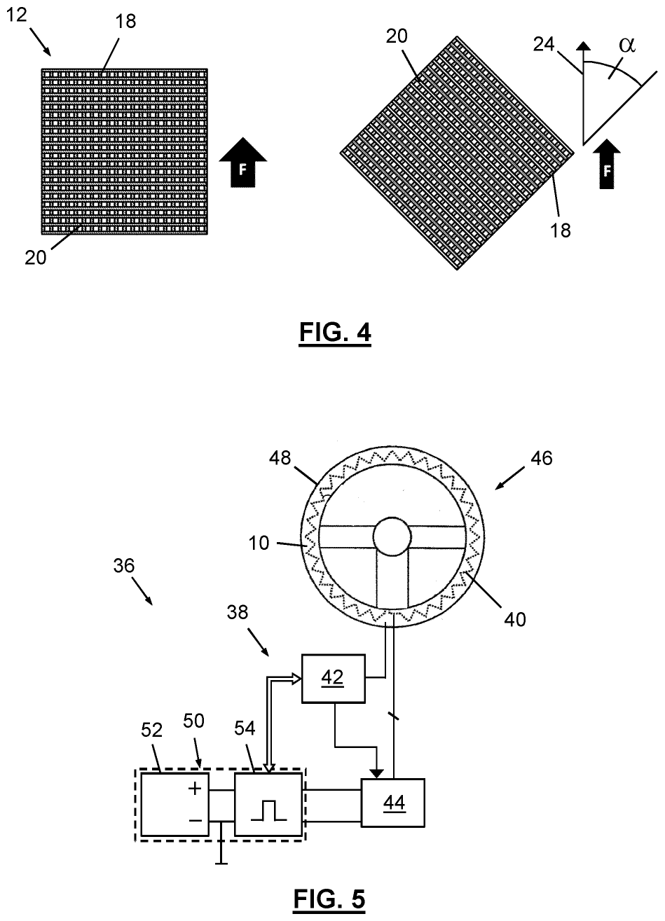

FIG. 4 shows a schematic representation of the electrically conductive, flat-shaped textile member 12 of the electric heating member 10 pursuant to FIG. 1 in a plan view, omitting the separation into the electrically conductive textile member parts 22. Gaps between adjacent warps 18 and wefts 20 are again highly exaggerated for clarity purposes.

The left part of FIG. 4 illustrates a situation as if the plurality of electrically conductive textile member parts were aligned such that extension directions of the plurality of electrically conductive textile member parts run in parallel to the warp yarns 18. As the warp 18 and waft yarns 20 are not elastic per se, they would provide high mechanical resistance against an outer force F applied in parallel to an extension direction of the warps 18 and wefts 20, respectively, resulting in little elongation and, thus, low stretchability. This is not a preferred solution.

The preferred solution for an orientation of the electrically conductive, flat-shaped textile member 12 of the electric heating member 10 pursuant to FIG. 1 is shown in the right part of FIG. 4. Here, the plurality of electrically conductive textile member parts 22 is aligned such that extension directions 24 of the plurality of electrically conductive textile member parts 22 form an acute angle a with the warp yarns 18 that lies in a range between 15° and 75°. In this specific embodiment, the acute angle a is 45°. As the warp 18 and waft yarns 20 do not have to be elongated, they provide low mechanical resistance against an outer force applied in parallel to the extension direction 24 of the plurality of electrically conductive textile member parts 22. This results in a larger elongation of the electrically conductive, flat-shaped textile member 12, and, thus, to an increased stretchability.

FIG. 5 schematically shows a heatable vehicle steering wheel 46 of a passenger car with a capacitive hands-off detection system 36 using the electric heating member 10 pursuant to FIG. 1.

The capacitive hands-off detection system 36 includes a capacitive sensing device 38, a sense electrode 40 and a guard electrode, which is formed by the electric heating member 10. The capacitive hands-off detection system 36 is configured for detecting a presence of none, one or both of a driver's hands on the vehicle steering wheel 46. The phrase “being configured to”, as used in this application, shall in particular be understood as being specifically programmed, laid out, furnished or arranged.

In an installed and operational state, the sense electrode 40 and the guard electrode (i.e. the electric heating member 10) are arranged in parallel to each other, and are wound around and arranged on a major part of a rim 48 of the vehicle steering wheel 46. The electrically conductive sense electrode 40 and the electrically conductive guard electrode are proximal arranged to each other and are electrically mutually insulated.

The vehicle comprises a steering wheel electric heater power supply unit 50, which in this specific embodiment is fed by a starter battery of the vehicle. The electric heater power supply unit 50 includes a heating power source 52 and a controllable pulse-width modulation (PWM) switching unit 54 for controlling a provision of electric heating power to the electric heating member 10. The provision of electric heating power from the heating power source 52 is controllable by an electronic control unit 42 via the PWM switching unit 54, as is well known in the art.

The electronic control unit 42 and an AC decoupling circuit 44 form further parts of the capacitive hands-off detection system 36. The AC decoupling circuit 44 electrically connects the electric heater power supply unit 50 and the electric heating member 10 for providing electric power to the electric heating member 10 for heating the vehicle steering wheel 46.

Due to its flexibility and stretchability, the electric heating member 10 is easy to install even in the complex 3-D installation to the vehicle steering wheel 46. The electric heating member 10 provides uniform heating and, due to its uniform thickness t and uninterrupted and unaffected width w, shows in an installed state an as low as possible visibility and tactility.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, which is meant to express a quantity of at least two. The mere fact that certain measures are recited in mutually different dependent claims does not indicate that a combination of these measures cannot be used to advantage. Any reference signs in the claims should not be construed as limiting scope.

1. An electric heating member, comprising:
an electrically conductive, flat-shaped textile member of uniform thickness having a planar upper surface and a planar opposite lower surface arranged in parallel to the upper surface,
a layer of flexible, polymeric plastic material that is adhesively bonded to one out of the upper surface and the lower surface of the textile member, thus covering a major part of the respective surface,
wherein:
the electrically conductive textile member is formed by at least two electrically conductive textile member parts that are arranged side by side and are electrically separated by a kiss cutting process with regard to a direction that is perpendicular to an extension direction of the textile member parts, and wherein at least one of the at least two textile member parts is electrically connected to electric terminals that are connectable to an electric heater power supply unit.

2. The electric heating member as claimed in claim 1, wherein the textile member is formed by a plurality of more than two textile member parts that are arranged side by side and are electrically separated with regard to a direction that is aligned perpendicular to an extension direction of the textile member parts such that each adjacently arranged two textile member parts are mutually electrically separated.

3. The electric heating member as claimed in claim 1, wherein each textile member part of the plurality of more than two textile member parts is meander-shaped.

4. The electric heating member as claimed in claim 1, further comprising an adhesive layer that is adhesively bonded to the one of the surfaces of the textile member that is arranged opposite of the plastic material layer.

5. The electric heating member as claimed in claim 1, wherein the electrically conductive textile member is made for the most part from polyamide, polyester, or a combination of both.

6. The electric heating member as claimed in claim 1, wherein the electrically conductive textile member comprises warp and weft yarns, and wherein the two or the more than two electrically conductive textile member parts are aligned such that extension directions of the two or the more than two textile member parts form an acute angle with the warp yarns or the weft yarns that lies in a range between 15° and 75°.

7. A method of manufacturing an electric heating member, the method including at least the following steps:
providing an electrically conductive, flat-shaped textile member of uniform thickness having a planar upper surface and a planar opposite lower surface arranged in parallel to the upper surface,
adhesively bonding a layer of flexible, polymeric plastic material to one out of the upper surface and the lower surface of the textile member, thus covering a major part of the respective surface in a direction perpendicular to the respective surface, and
separating by a kiss cutting process the electrically conductive textile member into two or more electrically conductive textile member parts that are arranged side by side and are electrically separated with regard to a direction that is aligned perpendicular to an extension direction of the textile member parts such that each two adjacent textile member parts are mutually electrically separated.

8. The method as claimed in claim 7, further comprising a step of adhesively bonding an adhesive layer to the one of the surfaces of the textile member that is arranged opposite of the plastic material layer.

9. The method as claimed in claim 7, wherein the step of adhesively bonding a layer of flexible, polymeric plastic material is carried out using one out of a printing process, a commabar process or a slot die process.

10. An electric heating member as claimed in claim 1, installed in a vehicle steering wheel.

11. An electric heating member as claimed in claim 1 and comprising an antenna member of a capacitive sensing device for automotive application.
